(19) United States
(12) Patent Application Publication
(10) Pub. No.: US 2025/0122747 A1
(43) Pub. Date: Apr. 17, 2025

(54) DECORATIVE CABINET DOOR AND DRAWER HANDLE SURROUND

(71) Applicant: Morgan Uhl, Lutz, FL (US)

(72) Inventor: Morgan Uhl, Lutz, FL (US)

(21) Appl. No.: 18/910,462

(22) Filed: Oct. 9, 2024

Related U.S. Application Data
(60) Provisional application No. 63/543,627, filed on Oct. 11, 2023.

(51) Int. Cl. E05B 1/00

(52) U.S. Cl. CPC E05B 1/0084

(57) ABSTRACT

A handle surround with a torsional snap that is removably attachable to a fixed residential cabinet or drawer handle is described.

### CROSS-REFERENCE TO RELATED APPLICATIONS

This application claims priority benefit to U.S. Provisional Application No. 63/543,627, filed Oct. 11, 2023, which is incorporated herein by reference in its entirety.

### FIELD OF THE DISCLOSURE

The present disclosure relates generally to handles used on cabinet and drawer handles.

### BACKGROUND

Residential cabinet door and drawer handles, as illustrated in FIG. 1, are commonplace in households and countless other environments. Such handles are fixed to drawers or doors to facilitate moving the drawer or door between an open and a closed position. Given their prevalence and visibility, such handles are often provided in decorative finishes, patterns or designs intended to complement the location where the handle is fixed. Unfortunately, conventional handles have a number of drawbacks and shortcomings. For example, removal and replacement of conventional designs is costly in terms of material expenses, time-consuming and requires tools. As a result, given these characteristics, users replace conventional handles infrequently. Over time, such handles become outdated, outmoded and unsightly. Ultimately, this requires complete replacement of the handles.

In other alternatives, a cover is attached permanently to a door with the use of permanent adhesives or other attachment mechanisms requiring tools for removal. Indeed, removal of such conventional covers effectively disables the underlying handle because the cover functions as part of the handle. Further, removal of such conventional covers can be difficult, time-consuming and can even result in breakage of the cover or damage to the door or handle.

### SUMMARY

To improve upon the drawbacks and deficiencies of known cabinet door and drawer handles, the present disclosure provides a decorative surround that provides a snap joint connection to an existing handle without compromising the existing handle's function and purpose.

The present summary should not be construed to in any way narrow or constrain the claims of this disclosure, which alone define the scope of the inventions disclosed herein.

### BRIEF DESCRIPTION OF THE DRAWINGS

FIG. 1 illustrates a prior art cabinet door with a cabinet handle.

FIG. 2 illustrates a front view of a cabinet handle with a decorative handle surround.

FIG. 3 illustrates a perspective side view of a cabinet door with a handle having a decorative handle surround.

FIG. 4 illustrates a perspective side view of a cabinet or drawer handle having a decorative surround resembling a peppermint stick.

FIG. 5 illustrates a perspective bottom view of a cabinet or drawer handle having a decorative surround resembling a peppermint stick.

FIG. 6 illustrates an exploded perspective bottom view of a cabinet or drawer handle and a decorative handle surround.

FIG. 7 illustrates a perspective side view of a cabinet or drawer handle having a decorative surround resembling a candy cane.

FIG. 8 illustrates a perspective bottom view of a cabinet or drawer handle having a decorative surround in a candy cane configuration.

FIG. 9 illustrates a front view of a cabinet door having a handle covered with a decorative handle surround.

FIG. 10 illustrates a perspective side view of a chest of drawers having handles covered by decorative handle surrounds.

FIG. 11 illustrates a perspective side view of a latching decorative handle surround for use with a handle.

FIG. 12 illustrates a perspective side view of a decorative handle surround latched to a cabinet handle.

FIG. 13 illustrates a perspective side view of a decorative handle surround for use with a handle.

FIG. 14 illustrates a perspective side view of a decorative handle surround attached to a cabinet handle.

FIG. 15 illustrates a perspective side view of a latching decorative handle surround for use with a handle.

FIG. 16 illustrates a perspective side view of a decorative handle surround latched to a cabinet handle.

FIG. 17 illustrates a decorative handle surround latched to a cabinet door.

FIG. 18 illustrates a decorative handle surround having a nutcracker latched to a cabinet door.

FIG. 19 illustrates a decorative handle surround having a candle latched to a cabinet door.

FIG. 20 illustrates a decorative handle surround having a holiday character latched to a cabinet door.

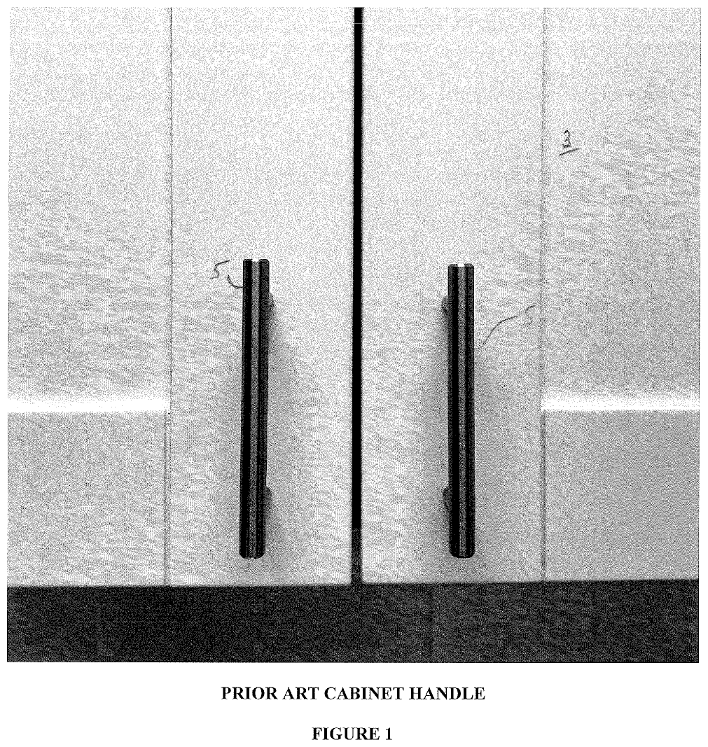

### DETAILED DESCRIPTION OF THE PREFERRED EMBODIMENTS

### Parts List

Cabinet Door (3)
Cabinet or Drawer Handle (5)
Handle Post (7)
Drawer (8)
Chest of Drawers (9)
Decorative Surround (10)
Channel (12)
Torsional Snap (14)
Ridge (16)
Decorative Exterior (18)
Latch (20)
Peg (26)
Passageway (30)

The following detailed description and the appended figures describe and illustrate features, structural characteristics, or operational characteristics of certain embodiments for the purpose of enabling one of ordinary skill in the relevant art to understand the disclosure. As such, the detailed description and figures are purely representative in nature and are not intended to limit the scope of the features described herein. It should also be understood that the figures may not be to scale and in certain instances details may have been omitted, which are not necessary for an understanding of the disclosed embodiments. In the accompanying figures, like numerals generally represent like components.

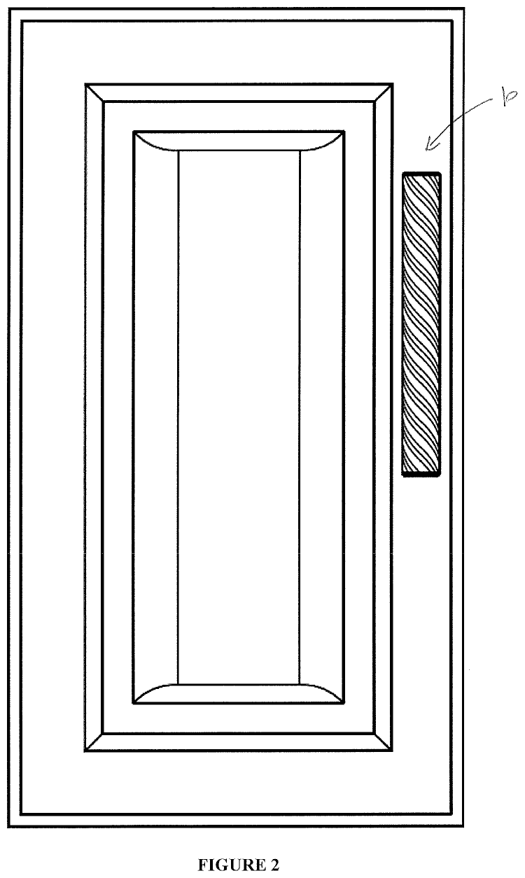

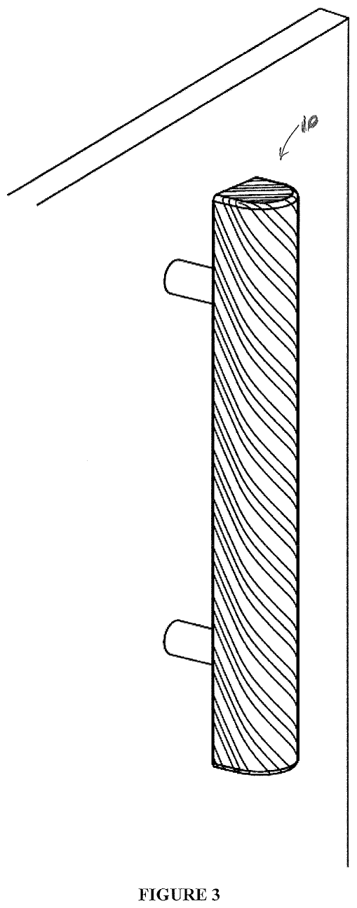

In one preferred embodiment, shown in FIGS. 2-5, a removable, decorative surround 10 includes a deformable channel 12, a torsional snap 14, and a decorative exterior 18. In general, surround 10 is formed from a polymer or rubber that is sufficiently flexible or deformable to permit outward flex of channel 12 and torsional snap 14 when surround 10 is pushed onto a handle 5. Given the deformable channel, handle surround 10 can be used on a wide variety handles 5 having different shapes and sizes.

In particular, when surround 10 is not in use, channel 12 and torsional snap 14 are in a nominal, resting or closed condition. In use, the surround is pushed onto handle 5, thus causing outward flex of channel 12 and snap 14 into a stressed or open condition that accommodates insertion of handle 5 into channel 12. Once handle 5 is situated in channel 12, channel 12 and torsional snap 14 return to their nominal, resting or closed condition, thus securing surround 10 to handle 5. As a result, a user can attach and remove surround 10 repeatedly to handle 5 without marring or damaging handle 5 or damaging surround 10. When surround 10 is connected to a handle, the handle continues to provide the functionality of allowing a user to pull or push the handle to open or close the door or drawer. That is, the opening and closing force applied by a user applied predominately to the handle, not surround 10. To remove handle surround 10, the user may hold the door/drawer in a fixed position, while pulling surround 10 away from door or drawer with sufficient force to deform channel 12 and snaps 14.

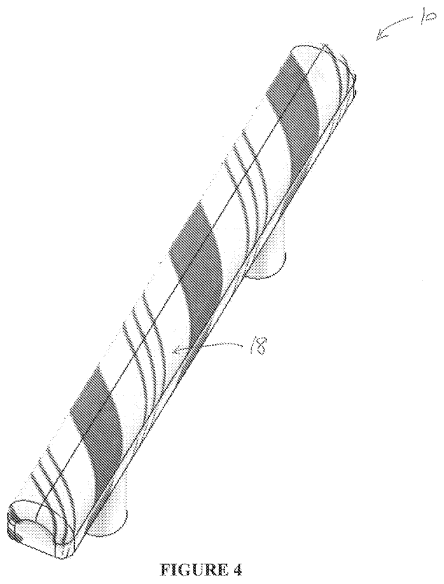

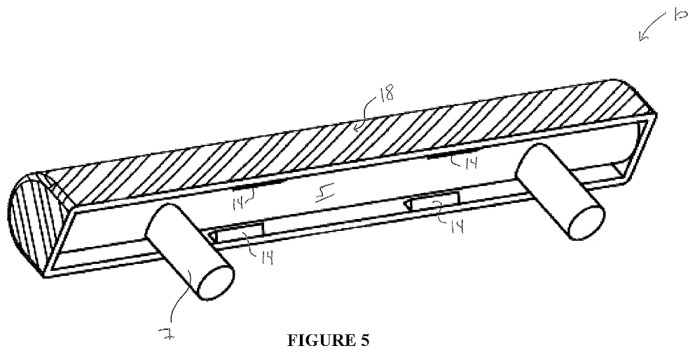

Referring to FIGS. 5-6, 8, and 13-14, surround 10 is provided with a plurality of torsional snaps 14. Generally, snaps 14 have a longitudinal ridge 16 that retains surround 10 on handle 5 when in use. Snaps 14 can be formed along channel 12. Preferably, four to six snaps are used to ensure that surround 10 is stably secured to handle 5. The use of multiple snaps permits use of surround 10 with handles that have a variety of longitudinal geometries, designs, sizes and finishes. Other embodiments can include eight or more snaps to further improve retention of surround 10 to handle 5. Alternatively, the length of each individual snap 14 can vary based on the size of the surround and the handle. For example, in an alternative embodiment, a single continuous snap can extend the entire perimeter of channel 12 to provide an improved, more-rigid connection to a handle. In another embodiment, rubber nodes can be used together with or as an alternative to snaps 14. The use of snaps 14 or nodes provides a secure connection to a handle without the need for adhesives, tapes or handle grooves that correspond with snaps 14.

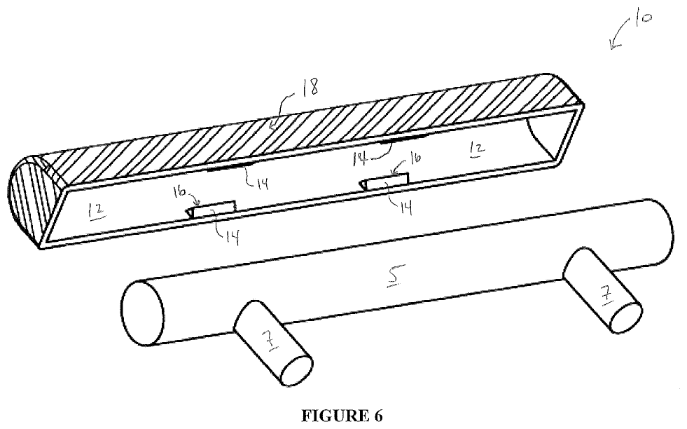

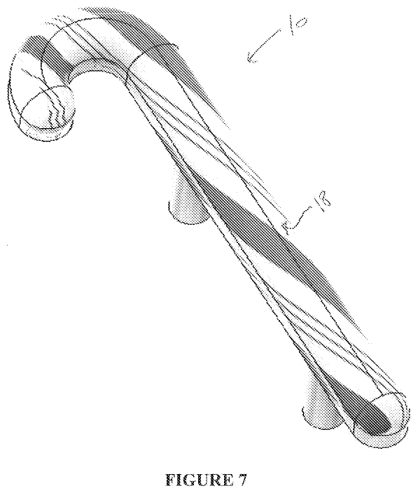

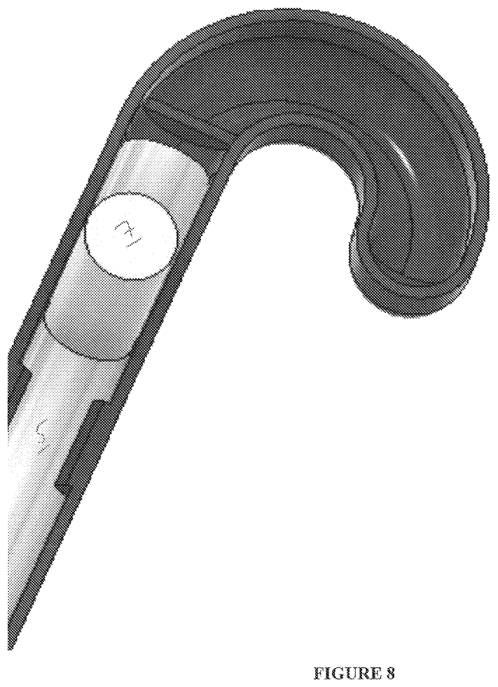

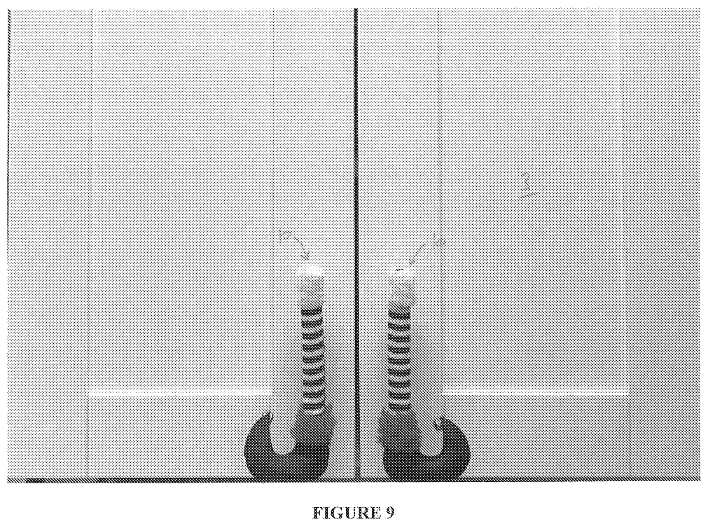

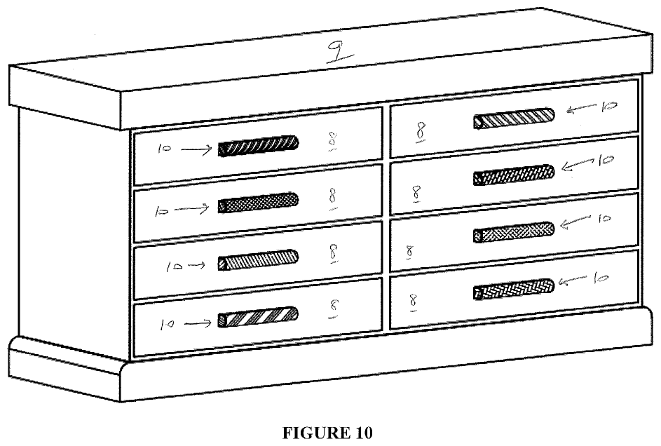

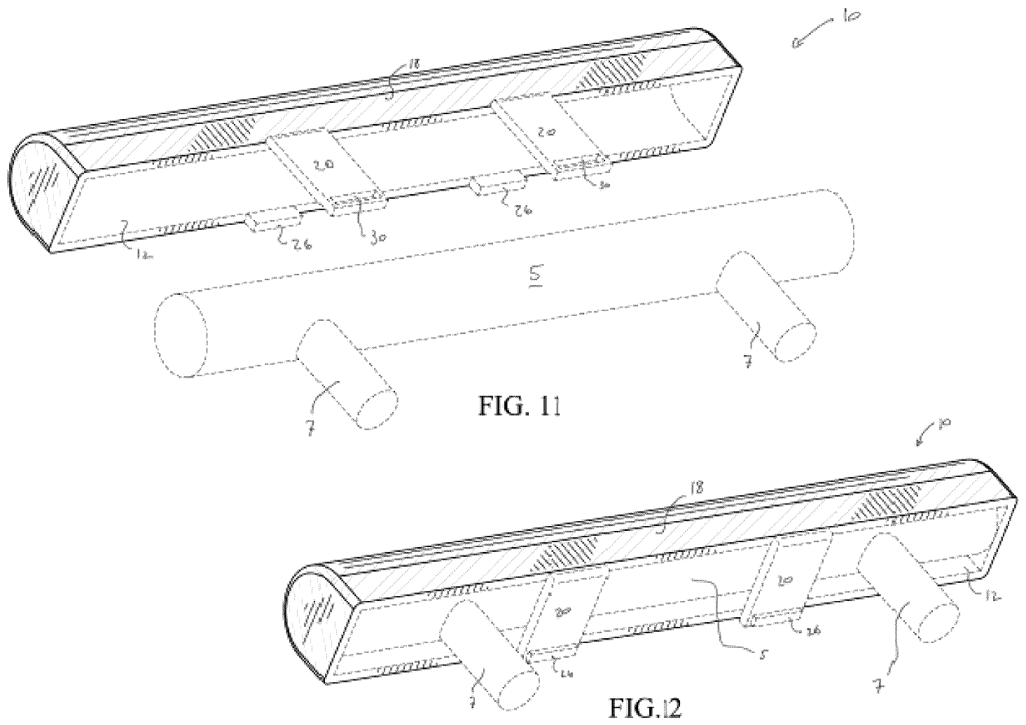

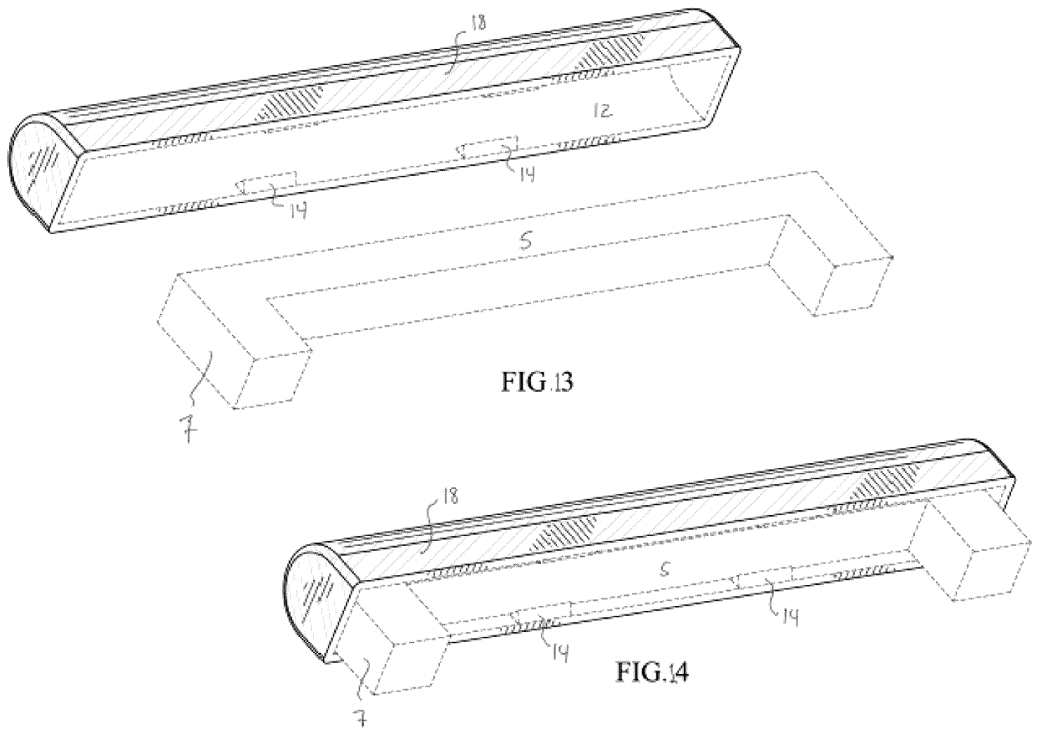

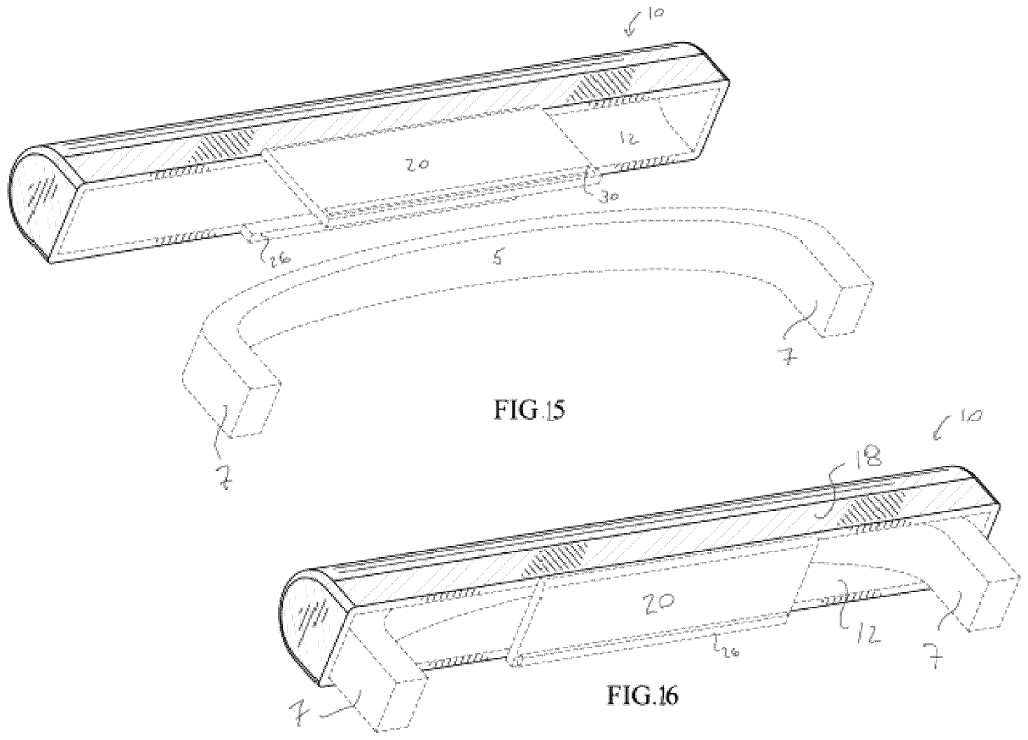

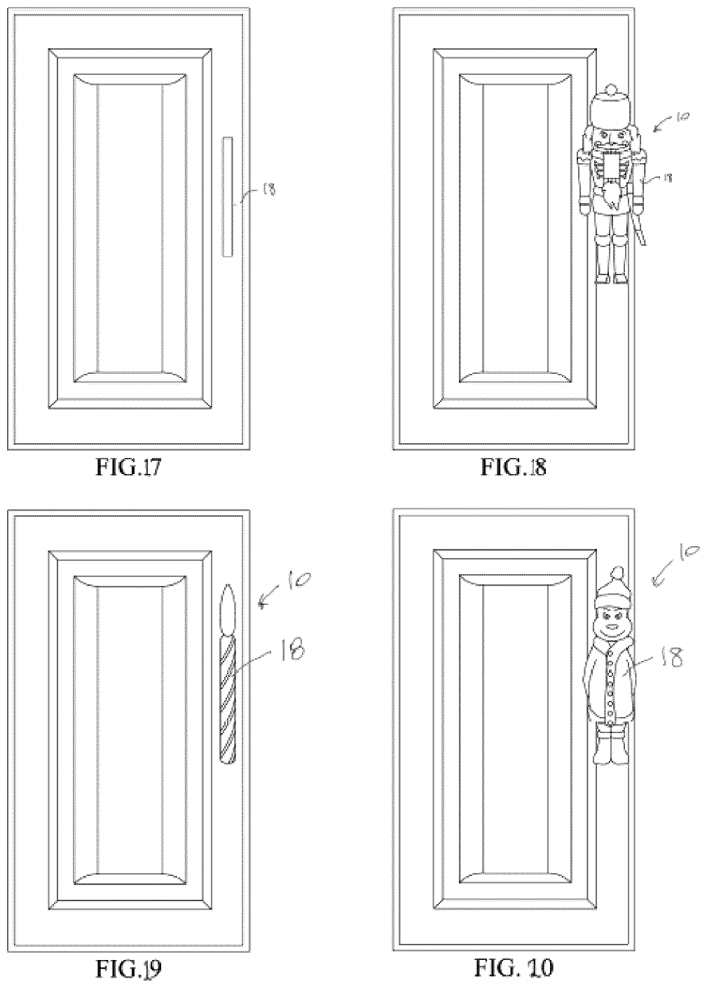

Referring to FIGS. 7 and 9-10, and 17-20, surround 10 is provided with a winsome decorative segment or exterior 18. Preferably, decorative exterior 18 can be provided in various themes. For example, suitable themes include: holidays such as Christmas or Hannukah; sports teams; seasons; special occasions such as birthdays or anniversaries; and boy's or girl's rooms. FIG. 5 depicts an exemplary peppermint stick decorative exterior 18, and FIG. 7 depicts and exemplary candy cane decorative exterior 18. Surround 10 can also be provided in modern, antique or other styles so as to coincide and harmonize with existing hardware and room décor. Decorative exterior 18, in particular, can be provided in a multitude of etchings, colors or other desired themes, as illustrated in FIGS. 9 and 17-20. For example, light emitting diodes that flash or create ambient lighting upon sensing movement or touch can be embedded into the handles during manufacture. Alternatively, small speakers that play holiday or special event music upon sensing movement or touch can also be used.

Decorative exterior 18, snaps 14 and channel 12 can be configured as separate parts that are glued or otherwise attached to each other, or alternatively, the entirety of handle surround 10 can be formed from a unitary piece of material, such as a thermoplastic elastomer, or silicone. Preferred materials include, for example, polymers, thermoplastic elastomers, or naturally-derived materials with a low durometer to avoid scratching or marring handle finishes. Such materials can be dishwasher safe so that handle surround 10 can be readily cleaned after use in children's rooms, kitchens or garages.

In another embodiment illustrated in FIGS. 11-12 and 15-16, surround 10 can be secured or connected to handle 5 with one or more straps or latches 20 with a hole or passageway 30 that snuggly receives a peg 26. Latch 20 swings from an open condition (shown in FIGS. 11 and 15) in which the surround can be fit over or receive handle 5, to a closed condition (shown in FIGS. 12 and 16) in which latch 20 attaches to peg 26 through passageway 30 securely retains the surround over the handle. This particular embodiment is suitable for and facilitates attachment to handles having asymmetrical, curved or irregular handles.

Alternatively, handle surround 10 can be provided in over-sized or ergonomic configurations that facilitate opening and closing drawers and doors by individuals living with a disability or that have trouble reaching a particular handle.

The descriptions set forth above are meant to be illustrative and not limiting. Various modifications of the disclosed embodiments, in addition to those described herein, will be apparent to those skilled in the art from the foregoing description. Such modifications are also intended to fall within the scope of the concepts described herein. The disclosures of each patent, patent application and publication cited or described in this document are hereby incorporated herein by reference, in their entireties.

The foregoing description of possible implementations consistent with the present disclosure does not represent a comprehensive list of all such implementations or all variations of the implementations described. The description of some implementation should not be construed as an intent to exclude other implementations. For example, artisans will understand how to implement the disclosed technologies and techniques in many other ways, using equivalents and alternatives that do not depart from the scope of the present disclosure. It is thus intended that the embodiments disclosed in the specification be considered as illustrative or representative only, with a true scope and spirit of the features described in this disclosure being indicated by the following claims.

What is claimed is:

1. A decorative surround removably attachable to an elongate handle having a crossmember, the decorative surround comprising:
a first end, a second end, and an elongate channel between the first end and second end, the channel having a nominal width greater than the width of the crossmember;
a decorative segment between the first end and second end;
a first torsional snap formed on the channel, the torsional snap being moveable between a stressed position and an unstressed position, wherein the surround can be removably secured to the handle by moving the torsional snap from the unstressed position, to the stressed position and back to the unstressed position.

2. The handle surround of claim 1, wherein the torsional snap is formed from a material having a durometer substantially softer than the durometer of the elongate handle, whereby the decorative surround can be attached and removed from the handle without marring the surface of the handle.

3. The handle surround of claim 1, wherein the decorative surface is a peppermint stick.

4. The handle surround of claim 1, wherein the decorative surface is a candy cane.

5. The handle surround of claim 1, wherein the decorative surface forms a lightning bolt.

6. The handle surround of claim 1, wherein the surround comprises a light emitting diode connected to the decorative surface.

7. The handle surround of claim 1, wherein the surround comprises a sound emitting device connected to the decorative surface.

8. A decorative surround removably attachable to an elongate handle having a crossmember, the decorative surround comprising:
a first end, a second end, and an elongate channel between the first end and second end;
a decorative segment disposed over the channel;
a latch having a passageway;
a peg extending from the channel, wherein the latch is moveable between an open condition and a closed position, wherein in the closed condition the peg extends into the passageway.

9. The decorative surround of claim 8, wherein the decorative segment is a candle.

10. The decorative surround of claim 8, wherein the decorative segment is a themed character.

11. A decorative surround removably attachable to an elongate handle having a crossmember, the decorative surround comprising:
a first end, a second end, and an elongate channel between the first end and second end, the channel having a nominal width greater than the width of the crossmember;
a decorative segment disposed on the elongate channel; and
a first torsional snap formed from a material having a durometer substantially softer than the durometer of the elongate handle, the torsional snap being disposed on the channel, the torsional snap being moveable between a stressed position and an unstressed position, wherein the surround can be removably secured to the handle by moving the torsional snap from the unstressed position, to the stressed position and back to the unstressed position.

12. The handle surround of claim 11, wherein the decorative segment is a peppermint stick.

13. The handle surround of claim 11, wherein the decorative segment is a candy cane.

14. The handle surround of claim 11, wherein the decorative segment comprises a three-dimensional themed character.

15. The handle surround of claim 11, wherein the decorative segment comprises a three-dimensional themed object.

16. The handle surround of claim 11, wherein the surround comprises a light emitting diode connected to the decorative segment.
